(19) United States
(12) Patent Application Publication
(10) Pub. No.: US 2026/0243671 A1
(43) Pub. Date: Aug. 20, 2026

(54) TOMOGRAPHIC SCANNING SYSTEM AND METHOD FOR LASER-MODIFIED REGION

(71) Applicant: SPIROX CORPORATION, Hsinchu (TW)

(72) Inventors: Yao-Chou Yang, Hsinchu (TW); Feng-Chieh Li, Hsinchu (TW); Yen-Cheng Chao, Hsinchu (TW)

(21) Appl. No.: 19/239,946

(22) Filed: Jun. 17, 2025

Related U.S. Application Data
(60) Provisional application No. 63/760,664, filed on Feb. 20, 2025.

(51) Int. Cl. G01N 21/3563

(52) U.S. Cl. CPC G01N 21/3563; G01N 2201/06113; G01N 2201/105

(57) ABSTRACT

A tomographic scanning system and method for a laser-modified region are disclosed. The system includes a light source, an objective lens, a filter, a photodetector, and a computing device. Fundamental-frequency light emitted from the light source irradiates a solid material, generating nonlinear light in the laser-modified region via nonlinear optical effects. The objective lens adjusts the focal plane to scan the laser-modified region along a thickness direction. The filter removes the fundamental-frequency light and retains the nonlinear light, which is detected by the photodetector. The computing device processes signals of the nonlinear light to construct a three-dimensional geometric shape of the laser-modified region, enabling non-destructive, high-resolution internal structure analysis.

### CROSS-REFERENCE TO RELATED APPLICATION

This application claims the priority benefit of U.S. provisional application serial no. 63/760,664, filed February 20, 2025, the full disclosure of which is incorporated herein by reference.

### BACKGROUND

### Technical Field

The present invention relates to a method and system for detecting a laser-modified region of a solid material.

### Description of Related Art

With the rapid development of semiconductor packaging technology, traditional plated through-hole (PTH) technology is gradually encountering technical bottlenecks in high-frequency and high-density applications. Against this background, through-glass via (TGV) technology has emerged as a key enabling technology, offering superior electrical, mechanical, and thermal stability, making it one of the critical technologies for fifth/sixth-generation mobile communications (5G/6G), high-performance computing (HPC), 3D integrated circuits (3D-IC), automotive electronics, and artificial intelligence (AI) chip packaging.

The core technologies of the TGV process include laser modification, wet etching formation, and metallization filling. Among them, the laser modification technique is a key step to ensure high-precision via formation. It utilizes a femtosecond laser to alter the microscopic structure inside a glass substrate, thereby improving the selectivity and precision of the subsequent etching process.

The femtosecond laser technique is characterized by its ultrashort pulses (e.g., 10⁻¹⁵ seconds), enabling internal modification of glass through non-thermal effects arising from multiphoton interactions with the glass material, thereby enhancing the quality and yield of via fabrication. Using MHz/GHz pulse modes, the laser modification technique can achieve extremely high processing efficiency. For example, high aspect ratio (HAR, >1:80) via structures can be fabricated with a single via processing time reduced to as short as 350 milliseconds. In addition, multi-beam parallel processing technologies, such as Bessel beam or acousto-optic deflector (AOD), can raise throughput to an industrial level of 10,000 vias per second, thereby making TGV technology more competitive in the market.

Another critical impact of laser modification lies in the changes to the chemical and physical properties of the glass. After being irradiated by a femtosecond laser, localized regions inside the glass substrate undergo reduced density, changes in refractive index, and redistribution of internal stress. These changes increase the etching rate of the modified region, resulting in an etching selectivity of more than 100:1 compared to unmodified regions.

It is worth noting that the laser modification technique is not only applicable to glass materials but has also been successfully extended to high-hardness materials such as silicon carbide (SiC), demonstrating advantages equally critical to those in glass processing. Silicon carbide may exist in various forms including crystal ingots, substrates, and bulk materials, and is widely applied in crystal ingot slicing, semiconductor processing, mechanical pre-treatment, and chemical etching pre-treatment. Taking the slicing of silicon carbide crystal ingots for wafer fabrication as an example, due to the extremely high hardness of silicon carbide, conventional manufacturing processes can only rely on diamond wire sawing to cut the crystal ingots into wafers. This not only results in low cutting efficiency but also causes substantial material loss, leading to continuously increasing manufacturing costs.

To address the above issues, a novel silicon carbide crystal ingot slicing technique combining laser modification and external force separation has been developed. This technique utilizes an ultrafast laser (e.g., femtosecond laser) to induce multiphoton absorption effects inside silicon carbide, thereby generating micro-explosion zones and microcracks, which significantly reduce the local hardness and cohesion of the material. External force can then be applied to rapidly cleave the silicon carbide crystal ingot along the modified layer. This process can significantly improve slicing speed and effectively reduce material loss.

However, current analysis of laser-modified regions remains limited by existing technical methods. At present, only destructive techniques—such as scanning electron microscopy (SEM), energy-dispersive spectroscopy (EDS), Raman spectroscopy, and nanoindentation—can be used to observe cross-sections of the laser-modified regions in silicon carbide crystal ingots. It is difficult to non-destructively confirm the spatial extent and continuity of explosion zones and microcracks within the silicon carbide crystal ingot, which has become a technical bottleneck for quality control of laser modification.

Therefore, whether in enhancing etching selectivity in the through-glass via (TGV) process or achieving low-loss and high-speed separation in the processing of silicon carbide crystal ingots, the laser modification technique plays an indispensable role. However, regardless of whether it is applied to glass or silicon carbide materials, the quality and uniformity control of the laser-modified region remain significant technical challenges. For a long time, the inspection of laser-modified regions has mainly relied on automated optical inspection (AOI) systems, which are only capable of two-dimensional image analysis on the surface of materials. They can hardly provide effective information about the three-dimensional structures of laser-modified regions located inside the material. Once high-aspect-ratio vias or other three-dimensional laser-modified features are formed within the material, potential defects such as internal cracks, discontinuities, and poor chemical uniformity are often difficult to detect in time, let alone accurately evaluate.

Due to the current lack of available detection solutions on the market that can perform non-destructive, high-resolution three-dimensional scanning of laser-modified regions, quality control of laser modification remains heavily dependent on destructive analysis methods such as SEM, Raman spectroscopy, EDS, and nanoindentation for post hoc evaluation. This not only consumes significant time and labor but also cannot be applied to real-time or mass-production quality control. This technological gap has become a critical bottleneck limiting the production capacity and yield of TGV and silicon carbide laser processing.

### SUMMARY

Therefore, if a three-dimensional scanning system with high penetration and high resolution can be introduced, it is expected that comprehensive structural analysis and evaluation of the laser modified region can be achieved under non-destructive conditions, thereby further enhancing the reliability and mass-production capability of TGV and silicon carbide laser processing technologies.

In view of the above, one aspect of the present invention provides a tomographic scanning method for a laser-modified region. The method includes the following steps. (a) A light source is disposed above a solid material having a laser-modified region, so that the light source generates a fundamental-frequency light to scan the solid material. It allows the solid material to reflect, refract, and scatter the fundamental-frequency light, and allows the laser-modified region to generate nonlinear light via a nonlinear effect. The fundamental-frequency light has a wavelength in the range of 1000-2200 nm and can penetrate the solid material. (b) An objective lens is disposed between the light source and the solid material. (c) A filter is used to retain the nonlinear light and remove the fundamental-frequency light. (d) A photodetector is disposed behind the filter to receive multiple signals of the nonlinear light generated from the laser-modified region. (e) The distance between the objective lens and the solid material is adjusted such that the focal plane of the fundamental-frequency light, after passing through the objective lens, falls on the solid material and covers the laser-modified region. This allows the nonlinear light to pass through the filter and reach the photodetector for detection. (f) Step (e) is repeated while gradually changing the distance between the objective lens and the solid material. As a result, the focal plane moves along the thickness direction of the solid material. At each stay position of the focal plane, nonlinear light generated from the laser-modified region is collected. These signals are then used to construct a three-dimensional geometric shape of the laser-modified region.

In one embodiment of the present invention, the light source is an ultrashort-pulse laser light source.

In one embodiment of the present invention, the solid material is a glass solid material or a silicon carbide solid material.

In one embodiment of the present invention, the filter retains third-harmonic light of the nonlinear light.

In one embodiment of the present invention, the fundamental-frequency light is from an infrared laser having a wavelength of 1560 nm.

In one embodiment of the present invention, the laser-modified region is formed in the solid material in preparation for forming a via hole or for cutting the solid material.

Another aspect of the present invention provides a tomographic scanning system for a laser-modified region. The tomographic scanning system includes a light source, an objective lens, a filter, a photodetector, and a computing device. The light source is disposed above a solid material having a laser-modified region and is configured to generate fundamental-frequency light to scan the solid material. The fundamental-frequency light is reflected, refracted, and scattered by the solid material, and nonlinear light is generated in the laser-modified region via a nonlinear effect. The fundamental-frequency light has a wavelength in the range of 1000-2200 nm and is capable of penetrating the solid material. The objective lens is disposed between the light source and the solid material. The filter is used to retain the nonlinear light and filter out the fundamental-frequency light. The photodetector is disposed behind the filter and detects multiple signals of the nonlinear light generated from the laser-modified region. The computing device is signal-connected to the photodetector and is used to receive and process the signals. The distance between the objective lens and the solid material is gradually changed, such that the focal plane of the fundamental-frequency light, after passing through the objective lens, gradually moves along the thickness direction of the solid material. The photodetector collects the nonlinear light signals generated from the laser-modified region at multiple stay positions of the focal plane. The computing device constructs a three-dimensional geometric shape of the laser-modified region based on these signals.

In one embodiment of the present invention, the light source is an ultrashort-pulse laser light source.

In one embodiment of the present invention, the photodetector is a photodiode, an avalanche photodiode, a charge-coupled device, a photomultiplier tube, or any combination thereof.

In one embodiment of the present invention, the tomographic scanning system further comprises a galvanometric scanning system disposed in front of the light source. The galvanometric scanning system is used to reflect the fundamental-frequency light emitted from the light source and then irradiate the fundamental-frequency light onto the solid material. This enables the scanning position of the fundamental-frequency light on the solid material to be changed.

In one embodiment of the present invention, the solid material is a glass solid material or a silicon carbide solid material.

In one embodiment of the present invention, the filter retains third-harmonic light of the nonlinear light.

In one embodiment of the present invention, the laser-modified region is formed in the solid material in preparation for forming a via hole or for cutting the solid material.

In view of the above, a tomographic scanning system and method for a laser-modified region are provided. The tomographic scanning system and method for the laser-modified region enable real-time and non-destructive three-dimensional scanning, and can rapidly provide structural analysis results of the laser-modified region for real-time quality monitoring.

The foregoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later. Many of the attendant features will be more readily appreciated as the same becomes better understood by reference to the following detailed description considered in connection with the accompanying drawings.

### BRIEF DESCRIPTION OF THE DRAWINGS

To make the above and other aspects, features, advantages, and embodiments of the present invention more comprehensible, the accompanying drawings are briefly described as follows.

FIG. 1A is a schematic diagram showing the structure of a tomographic scanning system for a laser-modified region according to an embodiment of the present invention.

FIG. 1B is a schematic diagram showing the structure of a tomographic scanning system for a laser-modified region according to another embodiment of the present invention.

FIG. 2 shows side view and cross-sectional images of a laser-modified region formed in preparation for through-glass via (TGV) formation, along with schematic diagrams showing detection results of the laser-modified region, according to an embodiment of the present invention.

FIG. 3 shows side view and cross-sectional images of a normal laser-modified region formed in preparation for through-glass via formation, according to another embodiment of the present invention.

FIG. 4 shows side view and cross-sectional images of an abnormal laser-modified region formed in preparation for through-glass via formation, according to yet another embodiment of the present invention.

FIG. 5 is a schematic diagram showing a laser-modified region and microcracks in a silicon carbide crystal ingot.

FIG. 6A shows side view and cross-sectional images of a laser-modified region and microcracks in a silicon carbide crystal ingot according to an embodiment of the present invention.

FIG. 6B shows side view and cross-sectional images of microcracks in a silicon carbide crystal ingot according to another embodiment of the present invention.

### DETAILED DESCRIPTION

In view of the above, a tomographic scanning system and method for a laser-modified region of a solid material are provided. The tomographic scanning system and method for the laser-modified region can perform real-time, non-destructive three-dimensional scanning of the solid material and rapidly provide structural analysis results of the laser-modified region. In the following description, exemplary structures of the tomographic scanning system for the laser-modified region and exemplary methods for tomographic scanning of the solid material with the laser-modified region will be introduced.

To facilitate readers’ understanding of the embodiments of the present invention, certain technical details are provided along with corresponding figures for explanation. However, not all embodiments require these technical details. Some well-known structures or components are illustrated only schematically in the figures to simplify the content. Terms such as “connected” or “disposed” indicate that one component may be directly positioned on another, or may be connected via intermediate components. In contrast, terms such as “first,” “second,” and “third” are used merely to distinguish elements or portions and do not imply any particular order. Positional terms such as “lower” and “upper” describe the relationships between components and may include orientations other than those shown in the drawings.

To more comprehensively describe the implementation of the present invention, explanatory descriptions of different aspects and specific embodiments are provided below. These are not limited to any single form of implementation or application, but rather include features and method steps of multiple specific embodiments. Different embodiments may implement the same or equivalent functions and steps, demonstrating the flexibility of the present invention.

For convenience of description, the functions of the system are described in terms of various functional units and/or functional modules. In implementing the present invention, these functional units or modules may be realized in one or more software and/or hardware components. The present invention is described with reference to flowcharts and/or block diagrams of methods, devices, and computer program products according to the embodiments. Computer program instructions are input into a processor and executed to generate devices that perform the described functions. These instructions may be executed by a general-purpose computer, a dedicated computer, an embedded processor, or other programmable data processing equipment.

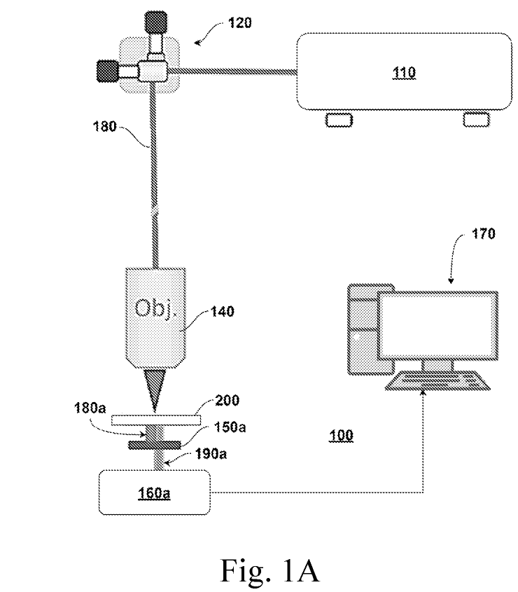

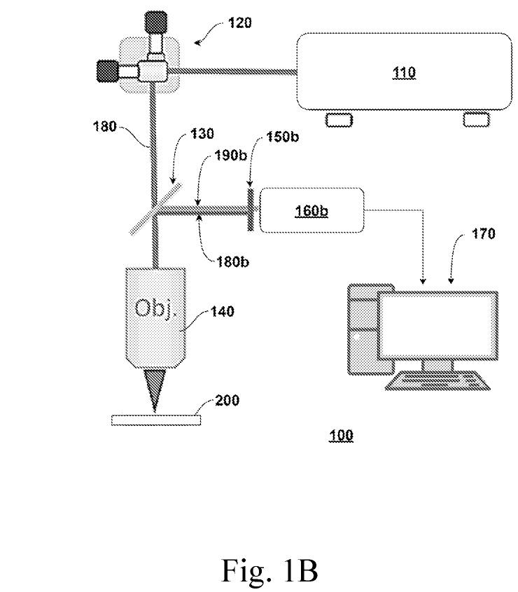

FIG. 1A is a schematic diagram showing the structure of a tomographic scanning system for a laser-modified region according to an embodiment of the present invention. The tomographic scanning system 100 for the laser-modified region is primarily used to perform precise non-destructive detection of a solid material that has undergone laser modification, in order to construct its three-dimensional geometric shape. This enhances process monitoring capability as well as the accuracy and reliability of subsequent etching steps. As shown in FIG. 1A, the tomographic scanning system 100 for the laser-modified region includes a light source 110, a galvanometric scanning system 120, an objective lens 140, a filter 150a, a photodetector 160a, and a computing device 170. The cooperation among these components ensures efficient optical signal filtering and high-resolution scanning of the laser-modified region.

The light source 110 is disposed above a solid material 200 having a laser-modified region (not shown in FIG. 1A), which is represented as a substrate in FIG. 1A. The light source 110 is responsible for generating fundamental-frequency light 180 and irradiating the solid material 200 with the fundamental-frequency light 180, causing reflection, refraction, and scattering phenomena within the solid material 200. In addition, when the fundamental-frequency light 180 is irradiated onto the laser-modified region, nonlinear optical characteristics of the laser-modified region cause it to generate nonlinear light 180a, thereby further enhancing detection sensitivity.

According to an embodiment of the present invention, the light source 110 may be an ultrashort-pulse laser light source, such as a femtosecond or picosecond laser source. The pulse width may be set in the range of 10⁻¹⁵ to 10⁻¹² seconds to ensure high penetration capability and precise temporal resolution, making it suitable for generating nonlinear optical effects. In addition, the fundamental-frequency light 180 generated by the light source 110 is near-infrared (NIR) light, with a wavelength range of 1000-2200nm, such as 1050nm or 1560nm. Laser light within this wavelength range not only effectively penetrates solid materials such as glass or silicon carbide, but also produces significant nonlinear optical phenomena, such as third-harmonic generation (THG). This further enhances the optical contrast between the laser-modified region and the surrounding unmodified region, thereby facilitating detection of the laser-modified region.

According to an embodiment of the present invention, the solid material 200 may be, for example, a glass solid material, a silicon carbide solid material, or another insulating solid material. The glass solid material may be, for example, a glass substrate, while the silicon carbide solid material may be a silicon carbide crystal ingot, a silicon carbide substrate, or a silicon carbide bulk material. When the solid material 200 is a glass substrate, its thickness may range from 5 to 3,000 μm to accommodate different packaging technology requirements. In addition, after laser modification, the physical and optical properties of the glass substrate undergo significant changes, such as changes in refractive index, reduction in density, and redistribution of internal stress. These changes affect the subsequent etching behavior. Therefore, by using the tomographic scanning system 100 for the laser-modified region as provided in the present invention, these parameters can be effectively monitored to improve process accuracy.

The galvanometric scanning system 120 may be disposed in the forward emission direction of the light source 110 and serves as a core component for optical scanning control. Its primary function is to adjust and guide the fundamental-frequency light 180 emitted from the light source 110, allowing the incident position on the solid material 200 to be dynamically changed during the scanning process. This enhances the overall flexibility and resolution of optical detection. When the fundamental-frequency light 180 passes through the galvanometric scanning system 120, the galvanometric scanning system 120 performs high-speed angular adjustments of the beam, ensuring that the laser light uniformly scans the surface of the solid material 200 and that complete scanning of the laser-modified regions in different areas of the solid material 200 is achieved.

The operation of the galvanometric scanning system 120 primarily relies on a high-speed oscillating galvo mirror, which deflects the light beam at high angular precision to change the scanning position of the fundamental-frequency light 180 on the solid material 200. This technique provides extremely high scanning speed and very low latency, enabling the detection system to capture and analyze optical signals in real time. In addition, by adjusting the control parameters of the galvanometric scanning system 120, the scanning range, beam repeatability, and scanning speed can be further enhanced to accommodate different types of solid materials and laser modification conditions.

The objective lens 140 may be disposed between the galvanometric scanning system 120 and the solid material 200, serving as a core component for optical signal collection and focusing. Its primary function is to ensure that the fundamental-frequency light 180a reflected from the galvanometric scanning system 120 is accurately focused onto the solid material 200, while simultaneously enhancing the collection efficiency of the nonlinear optical signal 190a generated from the solid material 200, thereby improving overall detection performance.

According to an embodiment of the present invention, the objective lens 140 may have a high numerical aperture (NA). This design helps enhance the efficiency of generating nonlinear optical signals. An objective lens 140 with a high numerical aperture provides stronger light field focusing capability, enabling the fundamental-frequency light 180a to generate stronger nonlinear effects inside the solid material 200, such as third-harmonic generation (THG). As a result, the optical signal contrast between the laser-modified region and the unmodified region is increased, thereby improving detection sensitivity.

According to another embodiment of the present invention, the objective lens 140 with a high numerical aperture not only enhances the efficiency of nonlinear light generation, but also optimizes the performance of nonlinear light collection. This means that the objective lens 140 can also increase the signal intensity collected by the photodetector 160a, thereby improving the signal-to-noise ratio (SNR) and ensuring high accuracy and stability of the optical signal. A high SNR reduces interference from background noise in the detection results, making the structure of the laser-modified region more clearly visible and further enhancing the ability of the tomographic scanning system 100 to identify the laser-modified region.

In addition, the selection of the objective lens 140 also affects the resolution and the depth of focus (DOF) of the system. Proper adjustment of the NA value can ensure that the fundamental-frequency light 180 is accurately focused at different depths within the solid material 200, thereby ensuring the acquisition of precise three-dimensional structural information during the tomographic scanning process.

By optimizing the optical characteristics of the objective lens 140, the tomographic scanning system 100 for the laser-modified region can effectively improve the imaging quality of the laser-modified region. This also ensures that the subsequent photodetector 160a can acquire high-resolution optical signals, thereby facilitating the construction of an accurate three-dimensional structural model.

The filter 150a is disposed below the solid material 200. Its primary function is to selectively retain the nonlinear light 190a from the solid material 200 and effectively filter out the fundamental-frequency light 180a, thereby ensuring that the subsequent detection system receives only the nonlinear optical signals from the laser-modified region. After being processed by femtosecond or picosecond laser, the optical properties of the laser-modified region change, such as the formation of a refractive index gradient or redistribution of internal stress, leading to the generation of nonlinear optical phenomena within the laser-modified region. Therefore, the design of the filter 150a is critical to ensuring the purity and accuracy of the detected signals.

According to an embodiment of the present invention, the filter 150a selectively transmits the nonlinear light 190a from the solid material 200, particularly retaining the nonlinear optical signal of third-harmonic generation (THG) of the fundamental-frequency light 180a. The wavelength of third-harmonic light is one-third that of the fundamental-frequency light. For example, when the wavelength of the fundamental-frequency light 180a is 1560nm, the resulting third-harmonic light is 520nm, which falls within the visible light range. The filter 150a can precisely select light within this wavelength range, ensuring that the photodetector 160a receives only the valuable nonlinear optical signals, thereby enhancing the sensitivity and accuracy of optical measurement.

By using a highly selective filter 150a, background signals of the fundamental-frequency light 180a from the solid material 200 can be effectively removed, thereby reducing noise interference and enhancing the resolution of the tomographic scanning system 100 for the laser-modified region. This design enables the photodetector 160a to acquire clear, high-contrast images of the laser-modified region, which facilitates the accurate construction of the three-dimensional structural model of the laser-modified region.

The photodetector 160a is disposed below the filter 150a. The primary function of the photodetector 160a is to detect and record the nonlinear light 190a that passes through the filter 150a and convert the collected optical signals into analyzable electrical signals. Since the intensity of the nonlinear light 190a is generally weaker than that of the fundamental-frequency light 180a, the sensitivity of the photodetector 160a directly affects the detection accuracy and signal quality of the system. Therefore, a high-sensitivity photodetector is selected to ensure that even weak nonlinear optical signals can be effectively captured and converted into stable electronic data.

According to an embodiment of the present invention, the photodetector 160a may use various high-performance photoelectric sensing elements, such as a photodiode (PD), an avalanche photodiode (APD), a charge-coupled device (CCD), a photomultiplier tube (PMT), or any combination thereof. Among them, the photodiode is suitable for general optical detection applications and offers high sensitivity and low noise. The avalanche photodiode provides higher photoelectric conversion efficiency than a standard PD due to its internal gain mechanism, making it suitable for detecting low-intensity optical signals. The charge-coupled device can be used for high-resolution image acquisition and is ideal for applications requiring optical tomographic scanning. The photomultiplier tube offers extremely high photon gain capability and can detect very weak optical signals, making it particularly suitable for the detection of high-precision nonlinear optical signals.

The computing device 170 is signal-connected to the photodetector 160a and is responsible for receiving, processing, and analyzing the signals of the nonlinear light 190a from the photodetector 160a. Since the tomographic scanning system 100 for the laser-modified region is required to generate high-resolution imaging of the modified region inside the solid material 200, the computing device 170 must possess powerful data processing capabilities to ensure accurate reconstruction of the three-dimensional geometric shape of the laser-modified region.

For example, to provide more precise structural analysis of the modified region, the tomographic scanning system 100 for the laser-modified region employs a layered focal plane scanning technique. By collecting nonlinear optical signals from different focal planes, a three-dimensional image of the laser-modified region is reconstructed. During this process, the computing device 170 performs image stacking to enhance image resolution and improve boundary contrast. This technique ensures that fine structures within the laser-modified region can be accurately presented and that variations in refractive index, stress distribution, and structural integrity can be identified. In addition, through image comparison algorithms, the computing device 170 can compare the scanned image with the original design shape of the laser-modified region to evaluate whether the laser modification conforms to the expected specifications.

FIG. 1B is a schematic diagram showing another system architecture of a tomographic scanning system for a laser-modified region according to another embodiment of the present invention. Compared with the structure shown in FIG. 1A, this embodiment primarily adds a dichroic mirror 130 and modifies the arrangement of the filter 150b and the photodetector 160b to provide an alternative optical signal collection approach. In this design, the tomographic scanning system 100 for the laser-modified region still includes the light source 110, galvanometric scanning system 120, objective lens 140, filter 150b, photodetector 160b, and computing device 170. The cooperation among these components ensures efficient optical signal filtering and high-resolution scanning of the laser-modified region.

The primary difference between FIG. 1B and FIG. 1A lies in the addition of a dichroic mirror 130 between the galvanometric scanning system 120 and the objective lens 140 in this embodiment. In addition, the arrangement of the filter 150b and the photodetector 160b is also modified, with both components placed above the solid material 200.

In the architecture of FIG. 1B, after the fundamental-frequency light 180 is emitted from the light source 110 and adjusted by the galvanometric scanning system 120, the beam first passes through the dichroic mirror 130 and is then focused onto the solid material 200 by the objective lens 140. When the beam irradiates the laser-modified region within the solid material 200, nonlinear optical effects occur, generating nonlinear light 190b. The optical signals generated inside the solid material 200 (including fundamental-frequency light 180b and nonlinear light 190b) propagate outward and are reflected by the dichroic mirror 130 positioned in the optical path. These signals are then directed toward the filter 150b on the right side. The filter 150b filters out the fundamental-frequency light 180b and retains only the nonlinear light 190b, allowing the subsequent photodetector 160b to receive only the nonlinear optical signals.

The remaining parts of FIG. 1B are the same as those in FIG. 1A and will not be described again.

### Tomographic Scanning Method For a Laser-Modified Region

To obtain a high-resolution three-dimensional shape of the laser-modified region, the tomographic scanning system 100 for the laser-modified region adopts a layer-by-layer scanning technique. By adjusting the focal plane position, complete three-dimensional image reconstruction is performed. The scanning process is described as follows.

First, the solid material 200 is placed below the objective lens 140 to ensure optical alignment and system stability. Then, the fundamental-frequency light 180a generated by the light source 110 is reflected by the galvanometric scanning system 120 and passes through the objective lens 140, causing the focal plane of the fundamental-frequency light to fall on the upper surface of the solid material 200. At this point, the tomographic scanning system 100 begins performing layer-by-layer scanning of the laser-modified region to obtain complete structural information of the region.

During the scanning process, the distance between the objective lens 140 and the solid material 200 is gradually adjusted, causing the focal plane of the fundamental-frequency light 180 passing through the objective lens 140 to move downward along the thickness direction of the solid material 200 until the focal plane of the fundamental-frequency light 180 reaches the lower surface of the solid material 200. As the focal plane moves, different depth layers within the laser-modified region are sequentially excited by the fundamental-frequency light 180, thereby generating corresponding nonlinear light 190a or 190b.

At each focal plane position, the nonlinear optical signals 190a or 190b from the laser-modified region are received by the photodetector 160a or 160b, respectively. Depending on the scanning configuration, when the tomographic scanning system 100 for the laser-modified region adopts the arrangement shown in FIG. 1A, the photodetector 160a collects the nonlinear light 190a after it passes through the filter 150a. When the system adopts the configuration shown in FIG. 1B, the nonlinear light 190b is reflected by the dichroic mirror 130, passes through the filter 150b, and is then detected by the photodetector 160b.

All collected optical signals are transmitted to the computing device 170 for signal processing, image reconstruction, and three-dimensional geometric shape analysis. Through the layered focal plane scanning technique, the computing device 170 stacks the nonlinear optical signals obtained at different focal plane positions to form a complete three-dimensional structural image of the laser-modified region. Then, the structural characteristics and quality of the laser-modified region are analyzed to ensure the accuracy of subsequent etching and processing steps.

Through the above scanning method, the tomographic scanning system 100 of the present invention provides a high-resolution, non-destructive detection technique for laser-modified regions. It enables precise monitoring of internal structural changes within the laser-modified region, thereby enhancing the reliability and production efficiency of TGV processing and silicon carbide mechanical machining.

### Experimental Example 1: Detection of a Laser-Modified in a Glass Substrate

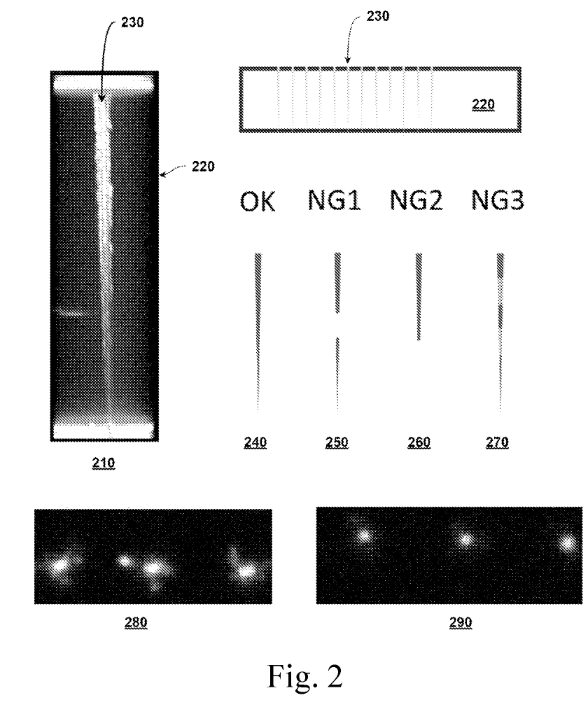

FIG. 2 shows side view and cross-sectional images of a laser-modified region formed in preparation for through-glass via (TGV) formation, along with schematic diagrams showing detection results of the laser-modified region, according to an embodiment of the present invention. In the third-harmonic optical image 210 of the side view of the glass substrate formed in preparation for TGV formation in FIG. 2, the laser-modified region 230 can be clearly observed. The laser-modified region 230 appears as a bright area within the black image of the glass substrate 220, indicating that the laser-modified region 230 has undergone laser modification treatment. This image reveals the morphological characteristics of the laser-modified region 230, which helps determine the structural integrity and uniformity of the laser-modified region 230.

In the upper right corner of FIG. 2, a schematic side-view diagram of the glass substrate 220 containing the laser-modified region 230 is shown. In addition, the images of laser-modified regions 240-270 illustrate classifications of different modification outcomes. The laser-modified region 240 represents a normal laser-modified region with complete and successful modification, showing a uniform shape without defects. The laser-modified regions 250-260 show abnormal regions in which part of the area was not successfully modified, possibly due to uneven laser energy or internal defects in the substrate, resulting in incomplete modification. The laser-modified region 270 exhibits abnormal internal non-uniformity within the laser-modified region, which may affect the selectivity of subsequent etching steps and the quality of via formation.

In addition, FIG. 2 also shows third-harmonic optical images 280-290 of cross-sections of the glass substrate formed in preparation for through-glass via formation. Among them, the third-harmonic optical image 290 shows a normal laser-modified region with a uniform cross-sectional shape and consistent optical characteristics. The third-harmonic optical image 280 shows an abnormal laser-modified region that may contain fractures, voids, or other irregular shapes, indicating that the modification process may have been affected by internal stress within the substrate, laser focal drift, or other variables.

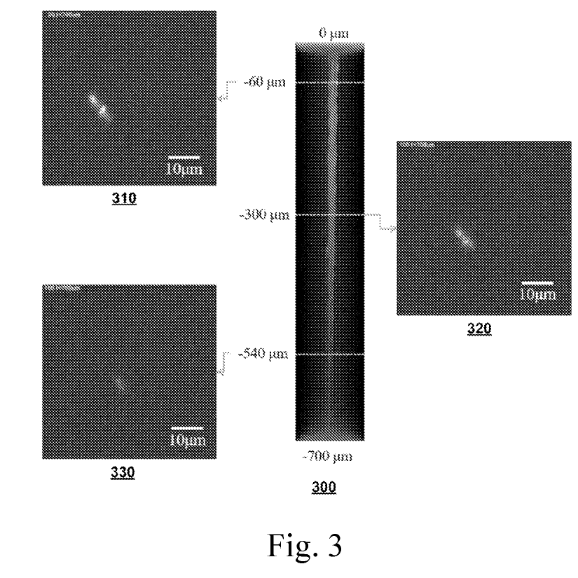

FIG. 3 shows side view and cross-sectional images of a normal laser-modified region formed in preparation for through-glass via formation, according to another embodiment of the present invention. In FIG. 3, a side-view third-harmonic optical image 300 of the laser-modified region is presented, and cross-sectional images at different depth positions are used to further analyze the uniformity and integrity of the laser-modified region. The third-harmonic optical images 310-330 at depths of -60 μm, -300 μm, and -540 μm inside the glass substrate show that the cross-sectional shape and quantity of the laser-modified region remain highly consistent across different depths. This indicates that the modification process is stable and highly reproducible. Such uniform laser-modified regions can ensure consistency in TGV formation during subsequent wet etching steps, thereby improving the reliability and yield of the TGV process.

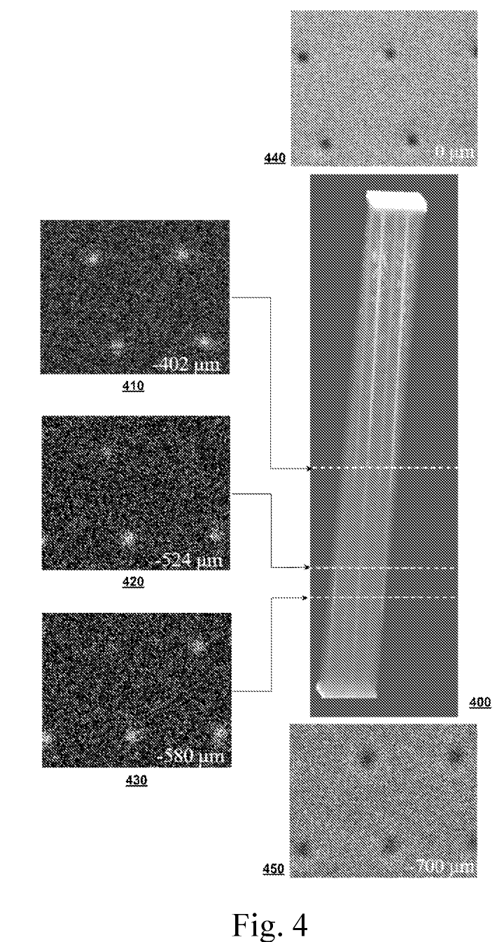

FIG. 4 shows side view and cross-sectional images of an abnormal laser-modified region formed in preparation for through-glass via formation, according to yet another embodiment of the present invention. In FIG. 4, a side-view third-harmonic optical image 400 of the laser-modified region is shown, along with third-harmonic optical cross-sectional images 410-450 at different depth positions. The analysis of the laser-modified region at various depths (0μm, -402 μm, -524 μm, -580μm, -700μm) reveals that, in some cross-sectional images, parts of the laser-modified region are not completely presented, indicating the presence of discontinuities.

Specifically, the third-harmonic optical image 440 at a depth of 0 μm shows the upper surface of the glass substrate, while the third-harmonic optical image 450 at a depth of -700μm shows the lower surface of the glass substrate. In the intermediate depth range, the third-harmonic optical images 410-430 reveal that some portions of the laser-modified region are not continuously visible, indicating that the laser modification did not penetrate through the entire thickness of the glass substrate. This discontinuity may be caused by laser focal drift, internal stress within the material, or attenuation of laser energy, resulting in non-uniform laser-modified regions. These abnormalities may affect the uniformity of subsequent wet etching steps, leading to incomplete via formation and adversely impacting the electrical performance and structural strength of the TGV.

From the above, it can be seen that the use of third-harmonic optical imaging technology enables real-time detection of the integrity of laser-modified regions prior to etching. This allows for early identification and correction of process issues, thereby improving the yield and reliability of through-glass vias.

### Experimental Example2: Detection of a Laser-Modified Region in Silicon Carbide Crystal Ingot

Since the crystal growth of silicon carbide (SiC) is difficult, the diameter of a typical silicon carbide crystal ingot is approximately 4 to 8 inches (10 to 20 cm), with a thickness of about 10 to 25 mm. In practical applications, the silicon carbide crystal ingot must be further sliced into wafers with a thickness of 150 to 350μm. Due to the extremely high hardness of silicon carbide, traditional cutting methods are not efficient. As a result, the industry has adopted laser modification technology to improve cutting efficiency and quality, while reducing material loss.

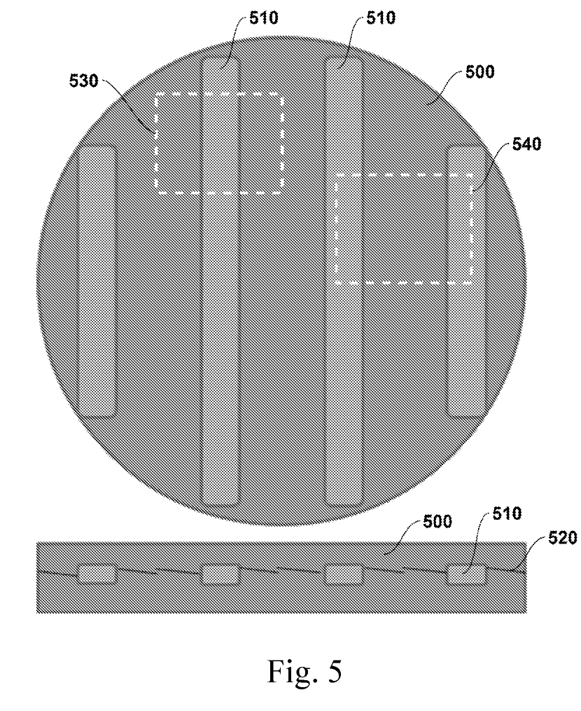

FIG. 5 is a schematic diagram showing a laser-modified region and microcrack plane in a silicon carbide crystal ingot. The upper portion illustrates a top view of the silicon carbide crystal ingot, and the lower portion illustrates a side view of the silicon carbide crystal ingot. When ultrafast laser (femtosecond laser) is used for modification, the laser is first focused on the laser-modified region 510 inside the silicon carbide crystal ingot 500. After substantial energy absorption, the silicon carbide initially dissociates into amorphous silicon and amorphous carbon, forming an initial modification layer. Subsequently, the continuously irradiated laser light is absorbed by the previously generated amorphous carbon, triggering micro-explosions due to volume expansion. This induces internal stress within the crystal ingot 500, leading to the formation of a microcrack-modified layer in the laser-modified region 510. Next, ultrasonic vibration is applied to the silicon carbide crystal ingot 500, allowing the vibration energy to propagate into the laser-modified region 510. This guides the growth of microcracks and connects previously disconnected cracks, ultimately forming a nearly continuous microcrack plane 520 within the crystal ingot 500. At this stage, the crystal ingot can be easily separated into wafers along the modified layer by applying tensile force using a vacuum chuck, effectively avoiding damage caused by rigid separation methods.

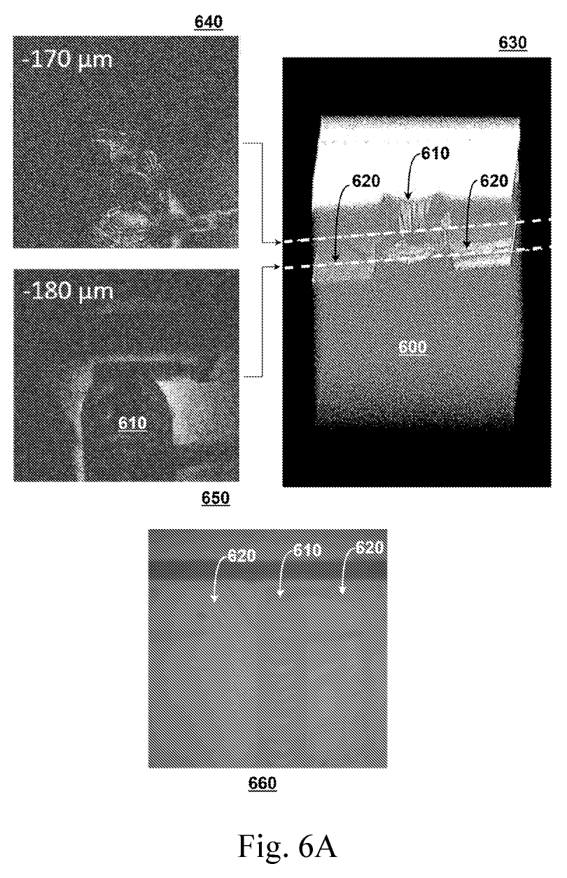

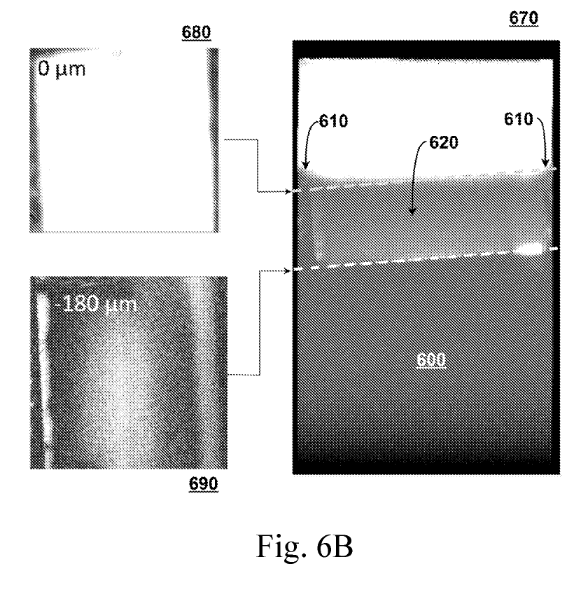

FIG. 6A shows side view and cross-sectional images of a laser-modified region and microcracks in a silicon carbide crystal ingot according to an embodiment of the present invention., with the image corresponding to region 530 in FIG. 5. In FIG. 6A, the laser modification depth of the silicon carbide crystal ingot 600 is 180 μm. The white-light optical image 660 at the bottom of FIG. 6A was obtained using a conventional optical microscope with white-light illumination, focused at a depth of 50μm below the surface of the ingot 600. However, this method cannot distinguish between laser-modified regions 610 and microcrack planes 620 at different depths. Therefore, third-harmonic generation (THG) imaging is needed to obtain more accurate information.

In the upper right corner of FIG. 6A is the side-view third-harmonic optical image 630 of the silicon carbide crystal ingot 600. The upper left shows the third-harmonic optical image 640 of the cross section at a depth of 170μm below the surface, and the third-harmonic optical image 650 of the cross section at a depth of 180 μm below the surface. In the third-harmonic optical image 650, a difference in third-harmonic intensity can be observed on both sides of the laser-modified region 610, confirming a depth offset between the microcrack planes 620 on either side of the laser-modified region 610. This observation is consistent with the microcrack plane 520 shown in the side view at the bottom of FIG. 5.

FIG. 6B shows side view and cross-sectional images of microcracks in a silicon carbide crystal ingot according to another embodiment of the present invention. The images shown in FIG. 6A correspond to region 540 in FIG. 5. On the right side of FIG. 6B is the side-view third-harmonic optical image 670 of the silicon carbide crystal ingot 600. On the left are the third-harmonic optical image 680 of the top surface (top-view image at surface depth) and the third-harmonic optical image 690 of the cross section at a depth of 180μm below the surface. By comparing the third-harmonic optical images at different depths, the formation and extension of the laser-modified region and the surrounding microcrack planes can be more clearly observed.

Through advanced optical detection techniques such as tomographic scanning, micro-explosion zones and the development of microcracks induced by laser modification can be clearly identified inside the silicon carbide crystal ingot. This also allows for precise determination of the depth and structural characteristics of the modified region. These observations not only assist in optimizing laser processing parameters to improve cutting efficiency and quality, but also provide more accurate evaluation and technical support for future laser modification applications in both glass substrates and silicon carbide materials.

The present invention provides a tomographic scanning system and method for a laser-modified region. This technology addresses the limitations of conventional detection methods by introducing a high-resolution, non-destructive, and real-time three-dimensional scanning technique that enables accurate observation and evaluation of the quality of laser-modified regions inside solid materials, including glass substrates and silicon carbide crystal ingots. Through this tomographic scanning system for laser-modified regions, not only can laser-modified regions prepared for through-glass vias in glass substrates be detected, but the system can also be extended to observe micro-explosion zones and microcrack planes formed in laser-modified regions of silicon carbide materials, thereby comprehensively enhancing process reliability and yield.

The tomographic scanning system described above employs fundamental-frequency light excitation and nonlinear optical effects to construct a three-dimensional structural model of the laser-modified region using a layer-by-layer scanning technique. This provides comprehensive and detailed internal modification information without causing any damage to the glass substrate or silicon carbide crystal ingot, thereby ensuring the integrity of the sample. With the use of a high-numerical-aperture objective lens and an ultrashort-pulse laser, the resolution of the scanning system can reach the submicron level (<0.5 µm), enabling precise detection of the three-dimensional structure of the laser-modified region and the distribution of defects caused by micro-explosions in silicon carbide materials.

When applied to through-glass via (TGV) processes, the tomographic scanning system can perform real-time monitoring of the laser-modified region after the laser modification step and before the wet etching step, preventing abnormal modifications from affecting the quality of subsequent etching. Compared with traditional automatic optical inspection (AOI), which is limited to observing the surface of the substrate, this scanning system can detect laser-modified regions inside the material. It enables rapid identification of whether the laser modification is complete and can detect abnormal areas that may impact etching or mechanical processing, such as incomplete modification, non-uniform modification regions, or crack issues. For laser-modified regions in silicon carbide crystal ingots, this tomographic scanning system can also detect the orientation and depth of microcracks caused by micro-explosions, helping optimize cutting parameters and reduce material loss.

The tomographic scanning system of the present invention is particularly suitable for high aspect ratio via processes, especially through-glass vias with an aspect ratio exceeding 1:80. By utilizing image stacking techniques, the tomographic scanning system ensures that the shape and quantity of the laser-modified regions remain consistent across different depths, thereby improving the stability of subsequent wet etching steps and enhancing the uniformity of the through-glass vias. At the same time, the system can also perform three-dimensional scanning of laser-modified regions in silicon carbide materials with greater thicknesses or varying ingot shapes, ensuring the continuity and completeness of the modified regions and further improving the efficiency and yield of silicon carbide processing.

In summary, the present invention provides a high-resolution, real-time, and non-destructive detection technique for laser-modified regions, which effectively addresses the inspection bottlenecks in the through-glass via (TGV) process for glass substrates and in the mechanical processing of silicon carbide crystal ingots. By utilizing nonlinear optical effects and optical signal filtering techniques, the tomographic scanning system proposed in this invention can precisely scan laser-modified regions inside solid materials and perform real-time quality monitoring. Whether the laser-modified region is formed in preparation for a through-glass via or as a result of micro-explosions in a silicon carbide crystal ingot, both the modified region and the associated microcracks can be fully reconstructed and measured, thereby ensuring process stability and final product reliability.

Although the present invention has been disclosed through the foregoing embodiments, these embodiments are not intended to limit the scope of the invention. Various modifications and refinements may be made by those skilled in the art without departing from the spirit and scope of the invention. Therefore, the scope of protection of the present invention shall be defined by the appended claims.

What is claimed is:

1. A tomographic scanning method for a laser-modified region, comprising the following steps:
(a) disposing a light source above a solid material having a laser-modified region, so that the light source generates a fundamental-frequency light to scan the solid material, allowing the solid material to reflect, refract, and scatter the fundamental-frequency light, and allowing the laser-modified region to generate nonlinear light via a nonlinear effect, wherein the wavelength of the fundamental-frequency light is 1000-2200 nm and is capable of penetrating the solid material;
(b) disposing an objective lens between the light source and the solid material;
(c) using a filter to retain the nonlinear light and filter out the fundamental-frequency light;
(d) disposing a photodetector behind the filter to receive a plurality of signals of the nonlinear light generated from the laser-modified region;
(e) adjusting a distance between the objective lens and the solid material such that a focal plane of the fundamental-frequency light, after passing through the objective lens, falls on the solid material and covers the laser-modified region, so that the nonlinear light is capable of passing through the filter and then reaching the photodetector to detect the signals of the nonlinear light; and
(f) repeating the step (e) and gradually changing the distance between the objective lens and the solid material such that the focal plane of the fundamental-frequency light, after passing through the objective lens, gradually moves along a thickness direction of the solid material to perform tomographic scanning on the laser-modified region, and separately collecting the signals of the nonlinear light generated from the laser-modified region at a plurality of stay positions of the focal plane, so as to construct a three-dimensional geometric shape of the laser-modified region.

2. The tomographic scanning method for a laser-modified region of claim 1, wherein the light source is an ultrashort-pulse laser light source.

3. The tomographic scanning method for a laser-modified region of claim 1, wherein the solid material is a glass solid material or a silicon carbide solid material.

4. The tomographic scanning method for a laser-modified region of claim 3, wherein the filter retains third-harmonic light of the nonlinear light.

5. The tomographic scanning method for a laser-modified region of claim 3, wherein the fundamental-frequency light is from an infrared laser having a wavelength of 1050 nm or 1560 nm.

6. The tomographic scanning method for a laser-modified region of claim 1, wherein the laser-modified region is formed in the solid material in preparation for forming a via hole or for cutting the solid material.

7. A tomographic scanning system for a laser-modified region, comprising:
a light source disposed above a solid material having a laser-modified region for generating a fundamental-frequency light to scan the solid material, allowing the solid material to reflect, refract, and scatter the fundamental-frequency light, and allowing the laser-modified region to generate nonlinear light via a nonlinear effect, wherein the wavelength of the fundamental-frequency light is 1000-2200 nm and is capable of penetrating the solid material;
an objective lens disposed between the light source and the solid material;
a filter for retaining the nonlinear light and filtering out the fundamental-frequency light;
a photodetector disposed behind the filter for detecting a plurality of signals of the nonlinear light generated from the laser-modified region; and
a computing device signal-connected to the photodetector for receiving and processing the plurality of signals;
wherein a distance between the objective lens and the solid material is gradually changed such that a focal plane of the fundamental-frequency light, after passing through the objective lens, gradually moves along a thickness direction of the solid material to perform tomographic scanning, and the photodetector is used to collect the plurality of signals of the nonlinear light generated from the laser-modified region at a plurality of stay positions of the focal plane, and the computing device is used to construct a three-dimensional geometric shape of the laser-modified region.

8. The tomographic scanning system for a laser-modified region of claim 7, wherein the light source is an ultrashort-pulse laser light source.

9. The tomographic scanning system for a laser-modified region of claim 7, wherein the photodetector is a photodiode, an avalanche photodiode, a charge-coupled device, a photomultiplier tube, or any combination thereof.

10. The tomographic scanning system for a laser-modified region of claim 7, further comprising a galvanometric scanning system disposed in front of the light source for reflecting the fundamental-frequency light emitted from the light source and then irradiating the fundamental-frequency light onto the solid material, so as to change a scanning position of the fundamental-frequency light on the solid material.

11. The tomographic scanning system for a laser-modified region of claim 7, wherein the solid material is a glass solid material or a silicon carbide solid material.

12. The tomographic scanning system for a laser-modified region of claim 11, wherein the filter retains third-harmonic light of the nonlinear light.

13. The tomographic scanning system for a laser-modified region of claim 7, wherein the laser-modified region is formed in the solid material in preparation for forming a via hole or for cutting the solid material.
